(19) United States
(12) Patent Application Publication
(10) Pub. No.: US 2025/0353514 A1
(43) Pub. Date: Nov. 20, 2025

(54) AUDIBLE GEOFENCE ALERTS FOR VEHICLE

(71) Applicant: Textron Inc., Providence, RI (US)

(72) Inventors: Christopher Alexander Boehm, North Augusta, SC (US); Cole Elliot O'Brien, North Augusta, SC (US)

(73) Assignee: Textron Inc., Providence, RI (US)

(21) Appl. No.: 18/666,983

(22) Filed: May 17, 2024

(51) Int. Cl. B60W 50/14; A63B 55/60; H04W 4/021

(52) U.S. Cl. CPC B60W 50/14; A63B 55/61; H04W 4/021; B60W 2050/143; B60W 2050/146; B60Y 2200/86

(57) ABSTRACT

A golf vehicle system includes a golf vehicle and a control system. The golf vehicle includes a chassis, a plurality of tractive assemblies coupled to the chassis, a prime mover configured to drive one or more of the plurality of tractive assemblies, and an indicator configured to provide one or more indications to an operator of the golf vehicle. The control system is configured to monitor a location of the golf vehicle relative to a restricted operation area of a golf course, and control the indicator to provide an indication responsive to a determination that the golf vehicle has entered the restricted operation area based on the location of the golf vehicle relative to the restricted operation area.

### BACKGROUND

Golf carts are commonly used by golfers while playing a round of golf to drive between holes, to their ball, and to carry their bags. Other vehicles, such as drink carts, ground maintenance vehicles, recreational vehicles, utility vehicles, etc. are also commonly found at a golf course. Keep-out geofences may be established around areas of the golf course where the golf carts and other vehicles should not drive. These areas may include greens, tee boxes, buildings, water, woods, among others. When the golf cart or the other vehicles drive in the area defined by the keep-out geofence, the operation thereof may be limited.

### SUMMARY

One embodiment relates to a golf vehicle system. The golf vehicle system includes a golf vehicle and a control system. The golf vehicle includes a chassis, a plurality of tractive assemblies coupled to the chassis, a prime mover configured to drive one or more of the plurality of tractive assemblies, and an indicator configured to provide one or more indications to an operator of the golf vehicle. The control system is configured to monitor a location of the golf vehicle relative to a restricted operation area of a golf course, and control the indicator to provide an indication responsive to a determination that the golf vehicle has entered the restricted operation area based on the location of the golf vehicle relative to the restricted operation area.

Another embodiment relates to a vehicle system. The vehicle system includes a non-transitory computer-readable medium having instructions stored thereon that, when executed by one or more processors, cause the one or more processors to monitor a location of a vehicle relative to a restricted operation area, and, in response to determining that the vehicle entered the restricted operation area based on the location of the vehicle relative to the restricted operation area, at least partially limit operation of a drivetrain of the vehicle, and provide an indication to an operator of the vehicle that the vehicle entered the restricted operation area.

Still another embodiment relates to a vehicle system. The vehicle system includes a non-transitory computer-readable medium having instructions stored thereon that, when executed by one or more processors, cause the one or more processors to monitor a location of a vehicle relative to a restricted operation area, in response to determining that the vehicle entered the restricted operation area based on the location of the vehicle relative to the restricted operation area, (i) at least partially limit operation the vehicle and (ii) provide a first indication to an operator of the vehicle that the vehicle entered the restricted operation area, and, in response to determining that the vehicle exited the restricted operation area based on the location of the vehicle relative to the restricted operation area, (i) stop limiting operation of the vehicle and (ii) provide a second indication to the operator of the vehicle that the vehicle exited the restricted operation area.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is a schematic block diagram of a site monitoring and control system including a plurality of the vehicles of FIG. 1, according to an exemplary embodiment.

FIG. 4 is a top view of a golf course including the vehicle of FIG. 1 and a plurality of geofences, according to an exemplary embodiment.

FIG. 5 is a top view of a golf course including the vehicle of FIG. 1 and a cart path geofence, according to an exemplary embodiment.

FIG. 6 is a block diagram of the vehicle of FIG. 1 transitioning from a drivable area to a restricted area defined by a geofence, according to an exemplary embodiment.

FIG. 7 is a block diagram of the vehicle of FIG. 1 within the restricted area defined by the geofence of FIG. 6, according to an exemplary embodiment.

FIG. 8 is a block diagram of the vehicle of FIG. 1 transitioning from the restricted area to the drivable area defined by the geofence of FIG. 6, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, the vehicle of the present disclosure includes an indicator configured to provide an indication to an operator of the vehicle. The indication may include an audible sound and/or a visual indication. The audible sound may be provided by an alert device connected to a controller of the vehicle, such as a buzzer, a horn, or a speaker. The visual indication may be provided by a display or one or more lights of the vehicle. The indication may alert the operator of an operation of the vehicle and/or a state of the vehicle. By way of example, the indication may be indicative of the operation of the vehicle such as whether the vehicle is operating in a first, unrestricted mode of operation, or in a second, limited mode of operation. By way of another example, the indication may be indicative of the state of the vehicle such as a location of the vehicle relative to a restricted operation area defined by a geofence.

Responsive to a determination that the vehicle is operating within the restricted operation area, the indicator provides the indication (e.g., an audible sound, a visual warning, etc.) to warn the operator that the vehicle is operating in the restricted operation area. In some embodiments, one or more operations of the vehicle are limited (e.g., cannot exceed a threshold speed, limited to rearward travel, etc.) when the vehicle is operating in the restricted operation area. In some embodiments, the indicator provides a first indication responsive to a determination of a transition of the vehicle from operating outside of the restricted area to operating within the restricted area, and the indicator provides a second indication different than the first indication responsive to the determination that the vehicle is operating within the restricted operation area. Responsive to a determination that the vehicle is operating outside of the restricted operation area (e.g., the vehicle has reversed to return to a drivable area), the indicator removes the indication to alert the operator that the vehicle is no longer operating in the restricted operation area. In some embodiments, the indicator provides a third indication different than each of the first and second indications to alert the operator that the vehicle is no longer operating in the restricted operation area. In some embodiments, normal or unrestricted operation of the vehicle is permitted when the vehicle is operating outside of the restricted operation area.

### Overall Vehicle

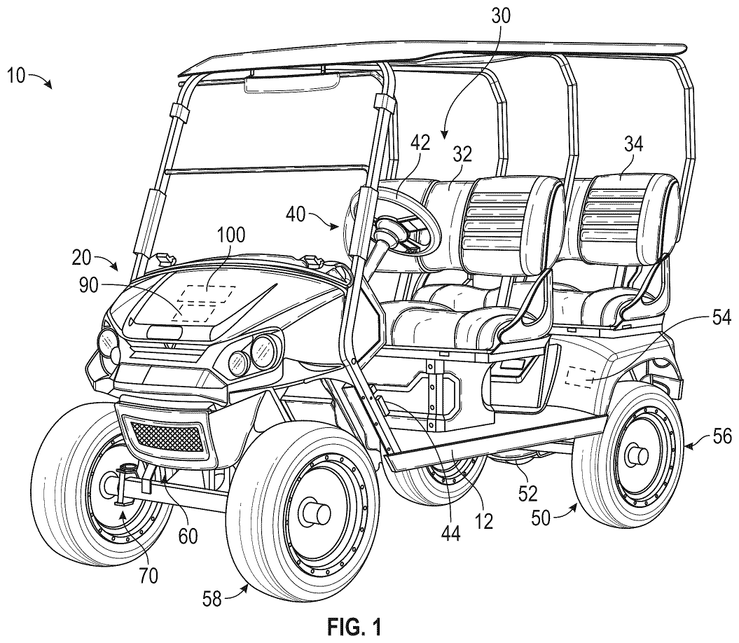

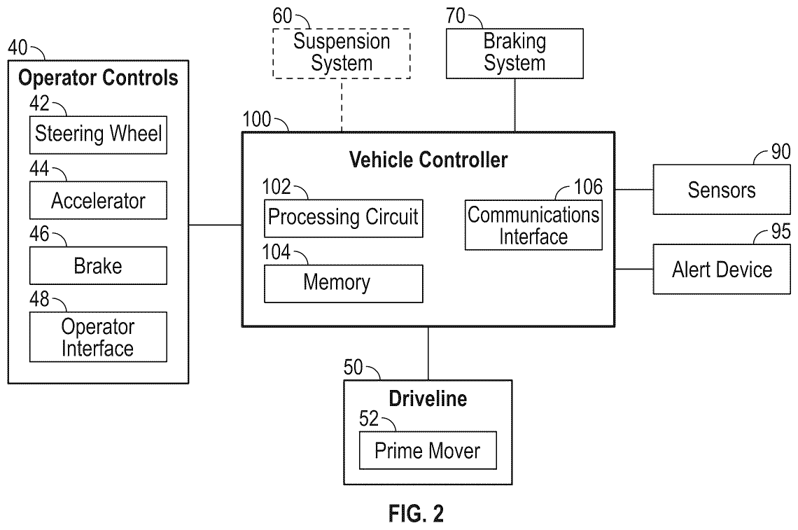

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; an indicator, shown as alert device 95; and a vehicle control system, shown as vehicle controller 100, coupled to the operator controls 40, the driveline 50, the suspension system 60, the braking system 70, the sensors 90, and the alert device 95. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart, an all-terrain vehicle (“ATV”), a utility task vehicle (“UTV”), a low speed vehicle (“LSV”), and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, and/or another type of chore product (e.g., that may be used on a golf course).

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system. In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

According to an exemplary embodiment, the alert device 95 is configured to generate and provide an indication (e.g., an audible sound, a visual indication, a warning, an alert, etc.) to an operator of the vehicle 10 and/or to an environment surrounding the vehicle 10. The alert device 95 is communicably coupled with the vehicle controller 100 and configured to provide the indication responsive to an activation signal received from the vehicle controller 100. In some embodiments, the alert device 95 includes a reverse buzzer (e.g., configured to provide an audible sound responsive to the vehicle 10 shifting into reverse), a horn of the vehicle 10, and/or a speaker configured to provide the indication. In such embodiments, the indication includes an audible sound such as a ring, a message, a tone, an alarm, or the like. The alert device 95 may provide the audible sound at one or more volume levels, frequencies, and patterns (e.g., a constant tone, a pulsing tone, a regular or irregular sequence of tones, etc.). In other embodiments, the alert device 95 includes one or more displays (e.g., a touchscreen, a LCD display, a LED display, gauges, warning lights, the operator interface 48, etc.) configured to provide the indication. In such embodiments, the indication includes a visual indication such as one or more lights emitted in various patterns, with various colors, at various frequencies, and/or with varying intensities or brightness. By way of example, the alert device 95 may emit pulsing lights, strobing lights, constant lights (e.g., spotlight), colored lights, etc.

The indication may be indicative of a mode of operation of the vehicle 10 (e.g., a reverse operation, a first mode of operation, a second mode of operation, etc.) or a state of operation of the vehicle 10 (e.g., a location of the vehicle 10 relative to a geofence). By way of example, the alert device 95 may provide a first indication of a first type (e.g., a constant tone, a tone at a first volume, a tone having a first pattern, etc.) indicative of a first mode of operation, a second indication of a second type (e.g., a pulsing tone, a tone at a second volume, a tone having a second pattern, etc.) indicative of a second mode of operation, etc. In such an example, the first type may be different than the second type. The indication may be produced to alert people surrounding the vehicle 10 of the operation and/or location of the vehicle 10.

The vehicle controller 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle controller 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle controller 100 may represent a collection of processing devices. In such cases, the processing circuit 102 represents the collective processors of the devices, and the memory 104 represents the collective storage devices of the devices.

In one embodiment, the vehicle controller 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle controller 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle controller 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Site Monitoring and Control System

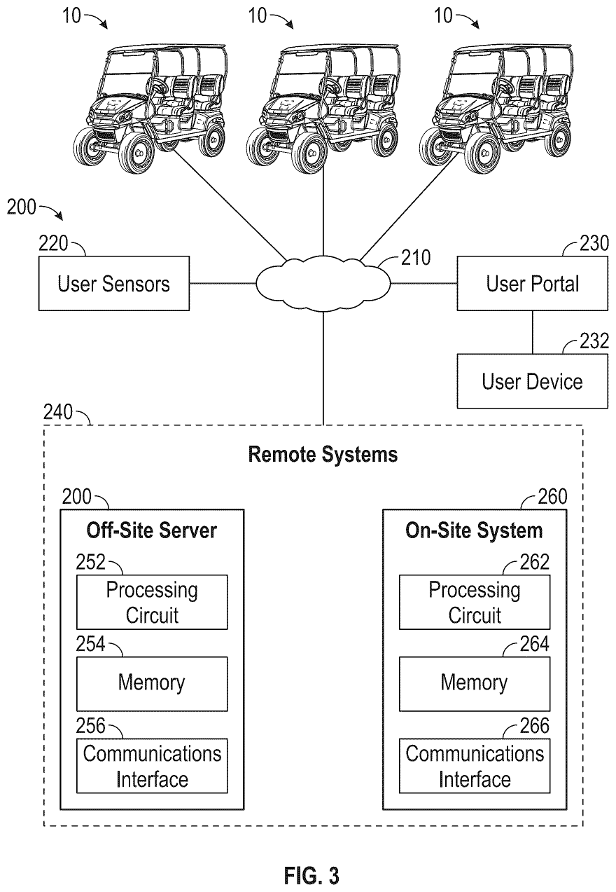

As shown in FIG. 3, a monitoring and control system, shown as site monitoring and control system 200, includes one or more vehicles 10; one or more second sensors, shown as user sensors 220, positioned remote or separate from the vehicles 10; an operator interface, shown as user portal 230, positioned remote or separate from the vehicles 10; an external or remote user device, shown as user device 232, positioned remote or separate from the vehicles 10 and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210.

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, hear rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc.; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons braking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). As shown in FIG. 3, the user portal 230 is accessible via the user device 232. The user device 232 may be or include a computer, laptop, smartphone, tablet, or the like. The user portal 230 and the user device 232 may communicate via one or more communications protocols (e.g., Bluetooth, Wi-Fi, cellular, radio, through the Internet, wired connection, etc.) through a network (e.g., a CAN bus, the communications network 210, etc.). The user device 232 includes a display (e.g., a screen, etc.) configured to display one or more graphical user interfaces (“GUIs”) of the user portal 230.

As shown in FIG. 3, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 3, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle controllers 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

### Geofence Alerts

According to an exemplary embodiment, the site monitoring and control system 200, including the vehicle controller 100, the user sensors 220, the user portal 230, and the remote systems 240, is configured to facilitate improving or enhancing location detection of the vehicles 10 and associated control thereof based on location. Further, it should be understood that any of the functions or processes described herein with respect to the site monitoring and control system 200 may be performed by the vehicle controller 100 and/or the remote systems 240. By way of example, data collection may be performed by the vehicle controller 100 and data analytics may be performed by the vehicle controller 100. By way of another example, data collection may be performed by the vehicle controller 100 and data analytics may be performed by the remote systems 240. By way of yet another example, data collection may be performed by the vehicle controller 100, a first portion of data analytics may be performed by the vehicle controller 100, and a second portion of data analytics may be performed by the remote systems 240. By way of still another example, a first portion of data collection may be performed by the vehicle controller 100, a second portion of data collection may be performed by the remote systems 240, and data analytics may be performed by the vehicle controller 100 and/or the remote systems 240.

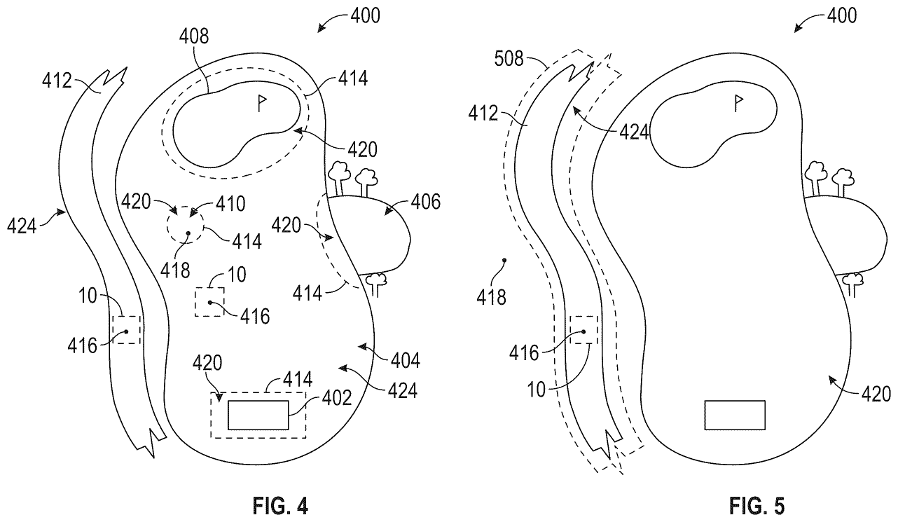

As shown in FIGS. 4 and 5, the vehicle 10 may be a golf cart driven by an operator playing golf on a golf course 400. In some embodiments, the vehicle 10 is a drink cart, a cart driven by an employee of the golf course 400 monitoring the pace of play of golfers, a cart driven by the maintenance crew working at the golf course 400, or another type of vehicle or vehicle commonly found at golf courses (e.g., a turf mower, a sprayer, an aerator, a bunker rake, etc.). A hole of the golf course 400 is shown including a tee box 402; a fairway 404; a water hazard, woods, fescue, etc., shown as out-of-bounds area 406; a putting green, shown as green 408; an area in the fairway 404 that is under repair, a non-playable area, etc., shown as hazard 410; and a path, a trail, a cart route, etc., shown as cart path 412.

The golf course 400 includes areas that should not be driven on, in, or around by the vehicle 10. By way of example, these areas may include the tee box 402, the out-of-bounds area 406, the fairway 404 during certain conditions (e.g., rain, flooding, under repair, etc.), the green 408, the hazard 410, private property along the golf course 400, a club house of the golf course 400, and/or another area of the golf course 400. Driving on, in, or around these areas by the vehicle 10 may damage the golf course 400, be dangerous for an operator of the vehicle 10, damage the vehicle 10, be illegal (e.g., trespassing on private property), etc. Collectively, these areas are hereinafter referred to as restricted areas 420. Accordingly, one or more geofences (e.g., a virtual boundary, a virtual fence, etc.), shown as geofences 414, may be established around the restricted areas 420. The geofences 414 may be areas or boundaries defined around the restricted areas 420 to control and manage the operation of the vehicle 10 on the golf course 400. By way of example, when the vehicle 10 is driven beyond the virtual boundary of the geofence 414 (i.e., driven into a restricted area 420), the operation of the prime mover 52 of the vehicle 10 may be limited (e.g., limit speeds below 5 miles per hour, prevent forward travel of the vehicle 10, limit the vehicle 10 to backward travel only, disabled, limited or restricted operation, etc.). Areas of the golf course 400, such as the cart path 412, a parking lot of the golf course 400, the fairway 404, a cart return area, etc. that are not restricted areas 420 (e.g., areas outside of the restricted areas 420) defined by a geofence 414 may be drivable (e.g., navigable, permitted, unrestricted operation, etc.) by the vehicle 10, and are hereinafter referred to as the drivable areas 424.

As shown in FIG. 5, in some embodiments, a cart path only rule may be implemented where the vehicle 10 is supposed to drive on the cart path 412 only (e.g., after or during heavy rainfall, to avoid ground under repair, when the cart path 412 is a bridge crossing a river/pond, etc.). In such instances, as shown in FIG. 5, rather than defining geofences around the restricted areas (i.e., everywhere but the cart path 412), a geofence, shown as cart path geofence 508, is formed around the cart path 412. By way of example, when the vehicle 10 is driven beyond the virtual boundary of the cart path geofence 508 (i.e., driven off of the cart path 412 and into a restricted area 420), the operation of the prime mover 52 of the vehicle 10 may be limited (e.g., limit speeds below 5 miles per hour, prevent forward travel of the vehicle 10, limit the vehicle 10 to backward travel only, disabled, limited or restricted operation, etc.).

As shown in FIGS. 4 and 5, a location (e.g., real-time position, actual location, etc.), shown as true location 416, of the vehicle 10 may be different than a tracked position of the vehicle 10 determined based on GPS data (e.g., collected by the sensors 90 and/or the user sensors 220), shown as tracked location 418. The error or difference between the tracked location 418 of the vehicle 10 and the true location 416 of the vehicle 10 may be caused by signal interference (e.g., geomagnetic radiation), solar storms, signal obstruction (e.g., tree cover, building cover, etc.), weather (e.g., rain, snow, pressure, etc.), control system quality, malfunctioning sensors, and/or any other combination of internal hardware or external factors. The difference between the tracked location 418 and the true location 416 may be referred to herein as location or GPS drift. Because of the difference between the tracked location 418 and the true location 416, the site monitoring and control system 200 may determine, based on the GPS position, that the vehicle 10 is operating in the restricted area 420 (e.g., near/on a green or tee box, near/on a hazard such as ground under repair, an area defined by a geofence, a non-drivable area, etc.) when in reality, the true location 416 of the vehicle 10 is not in the restricted area 420. In such an example, the site monitoring and control system 200 may undesirably limit the operation of the vehicle 10. Similarly, because of the difference between the tracked location 418 and the true location 416, the site monitoring and control system 200 may determine, based on the GPS position, that the vehicle 10 is not operating in the restricted area 420 (e.g., operating in the drivable area 424) when in reality, the true location 416 of the vehicle 10 is in the restricted area 420. In such an example, the site monitoring and control system 200 may undesirably permit operation of the vehicle 10 within the restricted area 420.

According to an exemplary embodiment, the site monitoring and control system 200 may be configured to correct (e.g., adjust for, account for, etc.) the undesirable controlling of the operation of the vehicles 10 as a result of the GPS drift. By way of example, the site monitoring and control system 200 may be configured to force the tracked location 418 to be within the drivable area 424 in response to a determination, based on the true location 416, that the vehicle 10 is traveling in the drivable area 424 and the tracked location 418 indicates that the vehicle 10 is in the restricted area 420. By way of another example, the site monitoring and control system 200 may be configured to force the tracked location 418 to be within the restricted area 420 in response to a determination, based on the true location 416, that the vehicle 10 is traveling in the restricted area 420 and the tracked location 418 indicates that the vehicle 10 is in the drivable are 424. By way of another example, the site monitoring and control system 200 may be configured to control operation of the vehicle 10 based on a corrective position determined using RTK information. In such an example, the corrective position may be based on corrective position data determined based on (i) communications between the on-site system 260 and a satellite (e.g., a global navigation satellite system (GNSS) satellite) and (ii) a known, fixed location of the on-site system 260. By way of yet another example, the site monitoring and control system 200 may be configured to control operation of the vehicle 10 based on the type of surface the vehicle 10 is driving on. In some embodiments, when a determination is made that the true location 416 is different than the tracked location 418 (e.g., the coordinates are different), the site monitoring and control system 200 may be configured to recalibrate (e.g., reset) the sensors 90 collecting the GPS data and/or send a signal commanding the user sensors 220 to recalibrate.

The site monitoring and control system 200 may control an operation of the operator controls 40, the driveline 50, the suspension system 60, the braking system 70, the alert device 95, and/or any other component of the vehicle 10 based on the true location 416 (e.g., a corrected position, an actual location, etc.) of the vehicle 10 relative to the restricted areas 420 and the drivable areas 424. By way of example, the site monitoring and control system 200 may determine, based on the true location 416, that the vehicle 10 is operating (e.g., driving forward, driving backward, idling, stopped, parked, etc.) (i) in a drivable area 424 defined by a respective geofence 414 or the cart path geofence 508, (ii) near a respective geofence 414 or the cart path geofence 508 (e.g., within 5 yards of the respective geofence 414 or the cart path geofence 508, within 10 yards of the respective geofence 414 or the cart path geofence 508, etc.), or (iii) in a restricted area 420 defined by a respective geofence 414 or the cart path geofence 508. In response to a determination that the vehicle 10 is operating in a drivable area 424, the site monitoring and control system 200 may facilitate (e.g., permit operation of the vehicle 10 in a first mode of operation) normal or unrestricted operation of the operator controls 40, the driveline 50, the suspension system 60, the braking system 70, and/or any other component of the vehicle 10. In response to a determination that the vehicle 10 is operating in or near a restricted area 420 (e.g., near or in the geofence 414, near or outside of the cart path geofence 508), the site monitoring and control system 200 may (i) limit operation (e.g., limit operation of the vehicle 10 in a second mode of operation) of the operator controls 40, the driveline 50, the suspension system 60, the braking system 70, and/or any other component of the vehicle 10 and/or (ii) activate the alert device 95. By way of example, the site monitoring and control system 200 may limit operation of the prime mover 52 such that the vehicle 10 (i) cannot exceed a threshold speed (e.g., 5 miles per hour, 2 miles per hour, etc.), (ii) is limited to rearward travel, and/or (iii) any other control to limit operation of the vehicle 10. In such an example, to transition the vehicle 10 to the second mode of operation, the site monitoring and control system 200 may (i) shift the vehicle 10 into neutral (e.g., such that no power is transmitted to the prime mover 52) and/or (ii) operate the braking system 70 to slow the vehicle 10 to a stop. The vehicle 10 may be limited to the second mode of operation until the vehicle 10 navigates (e.g., is navigated by an operator) to the drivable area 424.

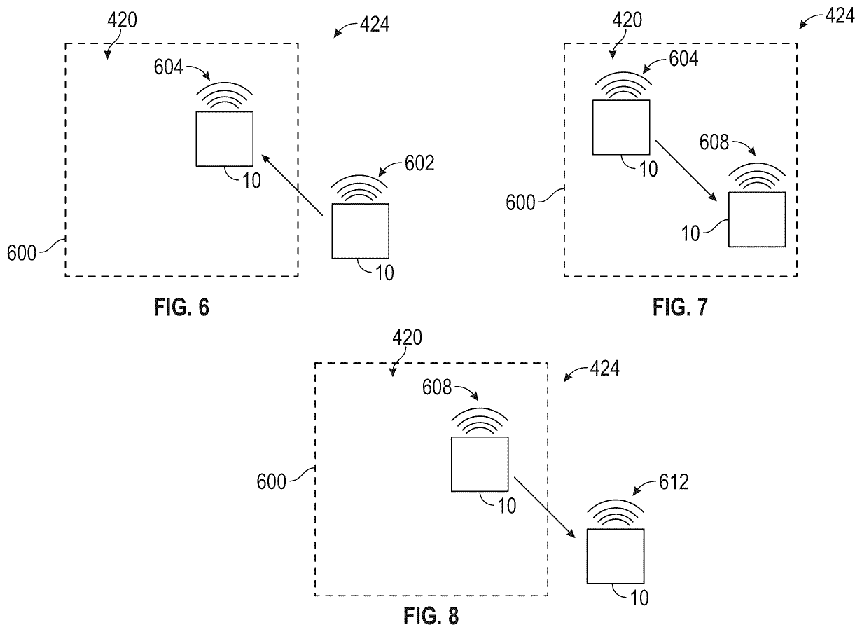

As shown in FIGS. 6-8, the restricted area 420 and the drivable area 424 are defined by a geofence 600. In some embodiments, the geofence 600 is a keep-out geofence such as the geofences 414 established around hazards and other non-drivable areas. In other embodiments, the geofence 600 is a cart path only geofence such as cart path geofence 508 established around the cart path 412 of the golf course 400. Referring to FIG. 6, the vehicle 10 is shown crossing the geofence 600 (e.g., a boundary thereof) and navigating from the drivable area 424 to the restricted area 420. Referring to FIG. 7, the vehicle 10 is shown navigating/operating within the restricted area 420 defined by the geofence 600. Referring to FIG. 8, the vehicle 10 is shown crossing the geofence 600 (e.g., a boundary thereof) and navigating from the restricted area 420 to the drivable area 424.

As shown in FIG. 6, in response to a first determination by the site monitoring and control system 200 that the vehicle 10 is driving in the drivable area 424, but approaching the restricted area 420 within a threshold distance (e.g., 1 yard, 5 yards, 10 yards, etc.), the alert device 95 generates and provides an indication, shown as first indication 602, regarding the operation and/or state of the vehicle 10. In some embodiments, the first indication 602 is not provided. As shown in FIG. 6, in response to a second determination by the site monitoring and control system 200 that the vehicle 10 is driven from the drivable area 424 to the restricted area 420 (e.g., crosses the geofence 600 from the drivable area 424 to the restricted area 420, crosses the geofence 414 from the drivable area 424 to the restricted area 420, crosses the cart path geofence 508 from the drivable area 424 to the restricted area 420), the alert device 95 generates and provides an indication, shown as second indication 604, regarding the operation and/or state of the vehicle 10. The second indication 604 may be the same as or different from the first indication 602.

As shown in FIG. 7, in response to a third determination by the site monitoring and control system 200 that the vehicle 10 is driving within the restricted area 420 (e.g., from a first location within the restricted area 420 to a second location within the restricted area 420, within the area defined by the geofence 600, within the area defined by the geofence 414, outside of the area defined by the cart path geofence 508, in reverse, etc.), the alert device 95 generates and provides an indication, shown as third indication 608, regarding the operation and/or state of the vehicle 10. The third indication 608 may be the same as or different from the first indication 602 and/or the second indication 604.

As shown in FIG. 8, in response to a fourth determination by the site monitoring and control system 200 that the vehicle 10 is driven from the restricted area 420 to the drivable area 424 (e.g., crosses the geofence 600 from the restricted area 420 to the drivable area 424, crosses the geofence 414 from the restricted area 420 to the drivable area 424, crosses the cart path geofence 508 from the restricted area 420 to the drivable area 424), the alert device 95 generates and provides an indication, shown as fourth indication 612, regarding the operation and/or state of the vehicle 10. The fourth indication 612 may be the same as or different from the first indication 602, the second indication 604, and/or the third indication 608. In some embodiments, the fourth indication 612 is the absence of the first indication 602, the second indication 604, and the third indication 608 (i.e., no visual and/or audible indication being provided).

In some embodiments, the first indication 602, the second indication 604, the third indication 608, and/or the fourth indication 612 include at least one of an audible sound or a visual indication indicative of (i) the position of the vehicle 10 relative to the geofence 600, (ii) a transition of the vehicle 10 between the restricted area 420 and the drivable area 424, and/or (iii) operation of the vehicle 10 within the geofence 600. In some embodiments, the first indication 602, the second indication 604, the third indication 608, and/or the fourth indication 612 provided by the alert device 95 are indicative of the state of the vehicle 10 (e.g., the location of the vehicle 10 within or near the restricted area 420 and/or the drivable area 424) and/or an operation of the vehicle 10 within the geofence 600 (e.g., operating in a forward drive mode, shifting or operating the vehicle 10 in reverse mode, etc.).

In embodiments where the first indication 602, the second indication 604, the third indication 608, and/or the fourth indication 612 include an audible sound, the first indication 602, the second indication 604, the third indication 608, and/or the fourth indication 612 may each be unique and different from each other. By way of example, responsive to the vehicle 10 approaching the geofence 600 from the drivable area 424, the alert device 95 may provide the first indication 602 having a first type (e.g., a first sound, a tone at a first volume, a tone having a first pattern, a first verbal message, etc.) and being indicative of the vehicle 10 approaching the geofence 600 of the restricted area 420 and should change course to avoid the restricted area 420. Responsive to the vehicle 10 crossing the geofence 600 from the drivable area 424 to the restricted area 420, the alert device 95 may provide the second indication 604 having a second type (e.g., a second sound, a tone at a second volume, a tone having a second pattern, a second verbal message, etc.) and being indicative of the vehicle 10 transitioning from the drivable area 424 to the restricted area 420 (e.g., indicative of the vehicle 10 transitioning from the first mode of operation to the second mode of operation, indicative operation of the vehicle 10 being limited to reverse only or a certain speed, etc.). Responsive to the vehicle 10 operating within the restricted area 420, the alert device 95 may provide the third indication 608 having a third type (e.g., a third sound, a constant tone, a tone at a third volume, a tone having a third pattern, a third verbal message, etc.) and being indicative of the vehicle 10 operating within the restricted area 420 (e.g., indicative of the vehicle 10 operating in the second mode of operation, being switched from drive to reverse, etc.). Responsive to the vehicle 10 crossing the geofence 600 from the restricted area 420 to the drivable area 424, the alert device 95 may provide the fourth indication 612 having a fourth type (e.g., a fourth sound, a tone at a fourth volume, a tone having a fourth pattern, a fourth verbal message, etc.) and being indicative of the vehicle 10 transitioning from the restricted area 420 to the drivable area 424 (e.g., indicative of the vehicle 10 transitioning from the second mode of operation to the first mode of operation).

In some embodiments, two or more of the first indication 602, the second indication 604, the third indication 608, or the fourth indication 612 provided by the alert device 95 are of the same type. By way of example, responsive to the vehicle 10 crossing the geofence 600 from the drivable area 424 to the restricted area 420, the indication provided by the alert device 95 may be of the same type until the vehicle 10 crosses the geofence 600 to return to the drivable area 424. In such an example, the second indication 604 and the third indication 608 are of the same type (e.g., collectively a restricted area operation indication) and different from that of the first indication 602 and the fourth indication 612.

In some embodiments, the second indication 604 and the fourth indication 612 are provided once responsive to crossing the geofence 600. In other embodiments, the second indication 604 and the fourth indication 612 are provided two or more times responsive to crossing the geofence 600. In some embodiments, the alert device 95 provides (e.g., constantly or at regular intervals) the second indication 604 and/or the third indication 608 until the vehicle 10 crosses the geofence 600 from the restricted area 420 to the drivable area 424, at which point the fourth indication 612 is provided (or the third indication 608 is stopped and the fourth indication 612 is omitted). In other embodiments, responsive to the vehicle 10 (i) crossing the geofence 600 from the drivable area 424 to the restricted area 420 and (ii) operating within the restricted area 420, the alert device 95 provides the second indication 604 and the third indication 608, of the same or of a different type, and does not provide the fourth indication 612 responsive to the vehicle 10 crossing the geofence 600 from the restricted area 420 to the drivable area 424. In other words, when the vehicle 10 is located, at least partially, within the restricted area 420, the alert device 95 provides an indication (e.g., the second indication 604, the third indication 608) such as a constant tone, and when the vehicle 10 transitions to the drivable area 424, the alert device 95 removes or otherwise stops providing the indication. In this manner, removing or otherwise stopping the indication from being provided is indicative of the vehicle 10 being located in the drivable area 424. In some embodiments, removing a portion of the indication being provided (e.g., causing periodic or pulsing tones) is indicative of the vehicle 10 transitioning from the restricted area 420 to the drivable area 424. By way of example, responsive to the vehicle 10 transitioning from the drivable area 424 to the restricted area 420, the alert device 95 provides the second indication 604, responsive to the vehicle 10 operating in reverse within the restricted area 420, the alert device 95 provides the third indication 608 (e.g., a constant tone, a reverse buzzer, etc.), and responsive to the vehicle 10 transitioning from the restricted area 420 to the drivable area 424, the alert device 95 provides the fourth indication 612 (e.g., a periodic or pulsing tone, cutting the reverse buzzer periodically, etc.). In such examples, the alert device 95 may periodically cut the constant tone (e.g., cut the third indication 608) to provide the pulsing tone (e.g., the fourth indication 608).

In some embodiments, the first indication 602, the second indication 604, the third indication 608, and/or the fourth indication 612 additionally or alternatively include a visual indication. By way of example, the alert device 95 may display a warning providing an indication to the operator of the vehicle 10 of the state of the vehicle 10 (e.g., the location of the vehicle 10 within or near the restricted area 420 and/or the drivable area 424) and/or an operation of the vehicle 10 (e.g., shifting or operating the vehicle 10 in reverse). As discussed in greater detail above, the first indication 602, the second indication 604, the third indication 608, and/or the fourth indication 612 may be displayed on one or more components of the vehicle 10 and include one or more lights emitted in various patterns, with various colors, at various frequencies, and/or with varying intensities or brightness. In some embodiments, responsive to approaching, entering, and/or operating within the restricted area 420, the first indication 602, the second indication 604, and/or the third indication 608 includes activating and/or flashing a light. Similarly, in some embodiments, responsive to exiting the restricted area 420, the fourth indication 612 includes changing and/or flashing a light in a different color or deactivating the light. In some embodiments, responsive to the vehicle 10 approaching or operating in the geofence 600, the alert device 95 displays a warning, instructions indicating how to navigate to the drivable area 424, a distance indicating how far the vehicle 10 is from or has traveled in the restricted area 420, and/or a time indicating how long the vehicle 10 has been operating in the restricted area 420. In some embodiments, responsive to the vehicle 10 exiting the geofence 600, the alert device 95 displays a notification indicating that the vehicle 10 is outside of the restricted area 420.

Using previous alert technology, the operator may not be provided an indication of when a vehicle has entered the restricted area 420 (other than operation of the vehicle being limited) or an indication of when the vehicle has returned to the drivable area 424 (e.g., reversed out of or otherwise exited the restricted area 420). Therefore, the operator can sometimes be taken off guard when the vehicle starts to operate differently (under limited operation within the geofence 600) and must periodically attempt to drive the vehicle forward to determine if the vehicle has exited the geofence 600 and will operate normally. However, by providing the various indications (e.g., audible sounds and visual indications) of the present disclosure, the operator becomes aware of when normal or unrestricted operation of the vehicle 10 is permitted. Further, the operator becomes aware of where the geofences 600, the restricted areas 420, and the drivable areas 424 are located and can operate the vehicle 10 accordingly (e.g., to return to or remain within the drivable areas 424).

As utilized herein with respect to numerical ranges, the terms “approximately,” “about,” “substantially,” and similar terms generally mean+/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the alert device 95, the vehicle controller 100, etc.) and the site monitoring and control system 200 (e.g., the remote systems 240, the user portal 230, the user sensors 220, etc.) as shown in the various exemplary embodiments is illustrative only. Additionally, any element disclosed in one embodiment may be incorporated or utilized with any other embodiment disclosed herein.

1. A golf vehicle system comprising:
a golf vehicle including:
a chassis;
a plurality of tractive assemblies coupled to the chassis;
a prime mover configured to drive one or more of the plurality of tractive assemblies; and
an indicator configured to provide one or more indications to an operator of the golf vehicle; and
a control system configured to:
monitor a location of the golf vehicle relative to a restricted operation area of a golf course; and
control the indicator to provide an indication responsive to a determination that the golf vehicle has entered the restricted operation area based on the location of the golf vehicle relative to the restricted operation area.

2. The golf vehicle system of claim 1, wherein the control system is configured to remove the indication responsive to a determination that the golf vehicle exits the restricted operation area.

3. The golf vehicle system of claim 1, wherein the indication is a second indication, wherein the control system is configured to control the indicator to provide a first indication prior to the second indication responsive to a determination that the golf vehicle is approaching but has not yet entered the restricted operation area, and wherein the first indication is different from the second indication.

4. The golf vehicle system of claim 1, wherein the indication is a first indication, and wherein the control system is configured to control the indicator to provide a second indication responsive to a determination that the golf vehicle has subsequently exited the restricted operation area after entering the restricted operation area.

5. The golf vehicle system of claim 4, wherein the first indication is different from the second indication.

6. The golf vehicle system of claim 1, wherein the control system is configured to control the indicator to continue to provide the indication while the golf vehicle is within the restricted operation area.

7. The golf vehicle system of claim 6, wherein the indication includes a first indication and a second indication, wherein the first indication is provided while the golf vehicle is in a drive mode of operation, wherein the second indication is provided while the golf vehicle is in a reverse mode of operation, and wherein the first indication is different from the second indication.

8. The golf vehicle system of claim 7, wherein the control system is configured to control the indicator to provide a third indication responsive to a determination that the golf vehicle has exited the restricted operation area.

9. The golf vehicle system of claim 8, wherein the second indication includes a reverse buzzer, and the third indication includes periodically cutting the reverse buzzer.

10. The golf vehicle system of claim 1, wherein the indication includes at least one of an audible sound or a visual alert.

11. The golf vehicle system of claim 10, wherein the indication includes the audible sound, wherein the indicator includes at least one of a reverse buzzer, a horn, or a speaker, and wherein the audible sound has a certain tone, a certain volume, a certain pattern, or a certain verbal message.

12. The golf vehicle system of claim 10, wherein the indication includes the visual alert, and wherein the indicator includes at least one of a display or a light.

13. The golf vehicle system of claim 1, wherein the control system is configured to:
permit unrestricted operation of the golf vehicle when the location of the golf vehicle indicates that the golf vehicle is located outside of the restricted operation area; and
limit operation of the golf vehicle when the location of the golf vehicle indicates that the golf vehicle is located in the restricted operation area.

14. The golf vehicle system of claim 1, wherein the control system includes one or more processing circuits including at least one of (a) a first processing circuit located on the golf vehicle or (b) a second processing circuit located remote from the golf vehicle.

15. A vehicle system comprising:
a non-transitory computer-readable medium having instructions stored thereon that, when executed by one or more processors, cause the one or more processors to:
monitor a location of a vehicle relative to a restricted operation area; and
in response to determining that the vehicle entered the restricted operation area based on the location of the vehicle relative to the restricted operation area:
at least partially limit operation of a drivetrain of the vehicle; and
provide an indication to an operator of the vehicle that the vehicle entered the restricted operation area.

16. The vehicle system of claim 15, further comprising the vehicle including:
a chassis;
a plurality of tractive assemblies coupled to the chassis;
a prime mover configured to drive one or more of the plurality of tractive assemblies; and
an indicator configured to provide the indication to the operator of the vehicle;
wherein the vehicle is a golf cart, an all-terrain vehicle, a utility task vehicle, a low speed vehicle, a lightweight or recreational vehicle, a lawnmower, a turf mower, a push mower, a ride-on mower, a stand-on mower, an aerator, a turf sprayer, or a bunker rake.

17. The vehicle system of claim 15, wherein the instructions, when executed by the one or more processors, cause the one or more processors to limit operation of the drivetrain to reverse only operation.

18. The vehicle system of claim 15, wherein the instructions, when executed by the one or more processors, cause the one or more processors to limit operation of the drivetrain to a speed below a reduced speed threshold.

19. The vehicle system of claim 15, wherein the instructions, when executed by the one or more processors, cause the one or more processors to at least one of:
stop providing the indication in response to the vehicle exiting the restricted operation area; or
provide a subsequent indication in response to the vehicle exiting the restricted operation area.

20. A vehicle system comprising:
a non-transitory computer-readable medium having instructions stored thereon that, when executed by one or more processors, cause the one or more processors to:
monitor a location of a vehicle relative to a restricted operation area;
in response to determining that the vehicle entered the restricted operation area based on the location of the vehicle relative to the restricted operation area:
at least partially limit operation the vehicle; and
provide a first indication to an operator of the vehicle that the vehicle entered the restricted operation area; and
in response to determining that the vehicle exited the restricted operation area based on the location of the vehicle relative to the restricted operation area:
stop limiting operation of the vehicle; and
provide a second indication to the operator of the vehicle that the vehicle exited the restricted operation area.
